(19) United States
(12) Patent Application Publication
(10) Pub. No.: US 2003/0188199 A1
(43) Pub. Date: Oct. 2, 2003

(54) Method of and device for information security management, and computer product

(75) Inventors: Tooru Tadano, Sendai (JP); Nobuhiro Nakazawa, Sendai (JP); Mikio Furuyama, Sendai (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/372,263

(22) Filed: Feb. 25, 2003

(30) Foreign Application Priority Data
Mar. 28, 2002 (JP) 2002-093169

(51) Int. Cl. G06F 11/30

(52) U.S. Cl. 713/201

(57) ABSTRACT

An information security system imposes restriction on information manipulation by a personal computer depending upon the location of uses of the personal computer. For example, access to the Internet may be allowed at certain location and access to certain data in the personal computer may be allowed at other locations.

### BACKGROUND OF THE INVENTION

1) Field of the Invention

The present invention relates to a technology for information security management that changes a capability of a computer to manipulate information or to access information access depending on a location where the computer is being used.

2) Description of the Related Art

So-called security systems of different types are being used at different places. For instance, a security system installed at a gate that pertains to restriction of entry or exit of persons, or a security system that pertains to restriction of carrying in or carrying out of gadgets, equipment, etc. In the field of computers and network, the security system may pertain to information related to a single computer that may require user ID and password in order to access data, or to server data such that may require personal identification or network connection, etc.

This kind of security system in which the data transfer or processing depends on supply of user ID/password does not discriminate where the computer is used as long as correct ID/password is supplied. Particularly, in this age of ubiquitous network and notebook sized personal computers (hereinafter “PC”), the user can practically transfer or access data from anywhere by merely logging in using the correct password.

This kind of security system that allows access to data by merely personal identification is not adequate and can potentially lead to information leakage. This system makes it very easy for information to be misused. When there is a personnel relocation, for instance, even if the change of the security system in the new place is carried out via a network/server administrator, until the time the change comes into effect, the old security system of supplying of personal identification could be a potential security breach.

Hence, no matter how one looks at it, a security system that depends only on supply of personal identification is an inadequate system.

### SUMMARY OF THE INVENTION

It is an object of this invention to at least solve the problems in the conventional technology.

The information security management method according to one aspect of the present invention comprises imposing restriction on manipulation of information by a portable computer based on a location of the portable computer.

The information security management method according to another aspect of the present invention comprises imposing restriction on information provided to a portable computer corresponding to a location of the portable computer based on information stored in a server that is connected to the portable computer via a network.

The computer program according to still another aspect of the present invention realizes on a computer detecting a location of the computer; and imposing restriction on manipulation of information by the computer based on the location of the portable computer.

The information security management device according to still another aspect of the present invention comprises a transmitter installed in each of a plurality of areas in which a computer may be used and each transmitter outputting a signal that indicates an area in which the transmitter is installed; a receiver that receives a signal transmitted by the transmitter in the area in which the computer is being used; and a control unit that imposes restriction on information manipulation by the computer based on the location indicated in the signal received by the receiver.

The information security management device according to still another aspect of the present invention comprises a receiver that receives a signal, which indicates a location of the a computer, transmitted by a global positioning system satellite; and a control unit that imposes restriction on information manipulation by the computer based on the location indicated in the signal received by the receiver.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic drawing of a computer system according to an embodiment of the present invention,

FIG. 2 is a block diagram of the computer system shown in FIG. 1,

FIG. 3 is a function block diagram of the computer system according to the embodiment,

FIG. 4 is a schematic drawing that shows a single area where a computer is to be used,

FIG. 5 is a schematic drawing that shows a plurality of areas where a computer is to be used,

FIGS. 6A to 6D show a data structure in detail,

FIGS. 7A to 7C show a data structure in detail, and

FIGS. 8A and 8B is a flow chart of security functions.

### DETAILED DESCRIPTION

An exemplary embodiment of an information security method, program and device is explained next with reference to the accompanying drawings.

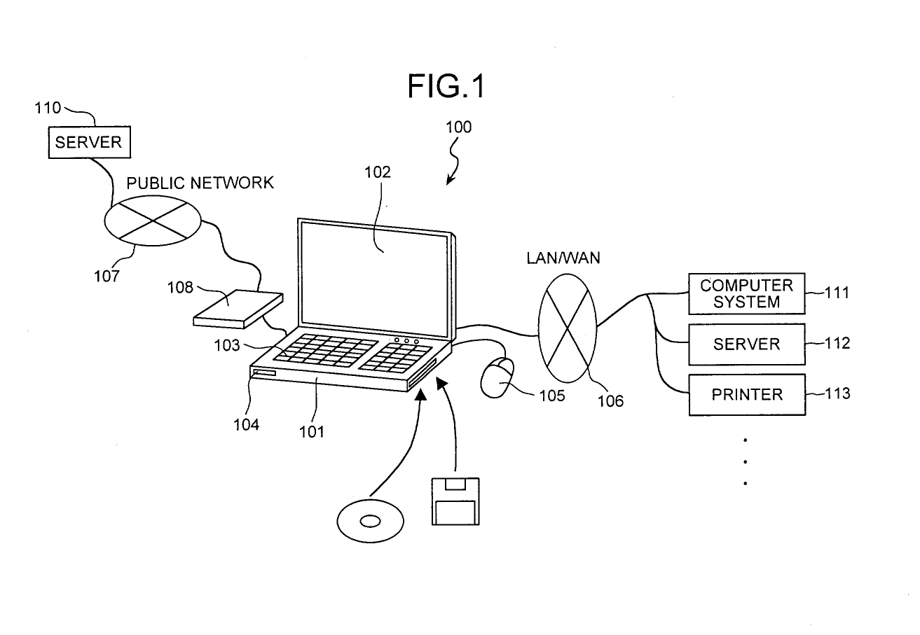

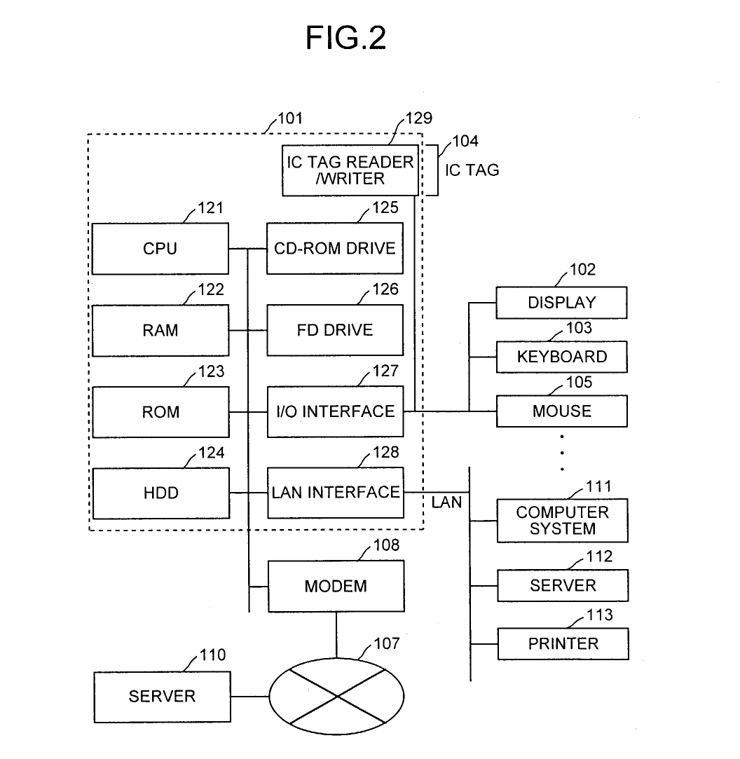

FIG. 1 is a schematic drawing of a computer system according to an embodiment of the present invention and FIG. 2 is a block diagram of the computer system.

This computer system comprises a notebook type portable PC 100. The PC 100 has a main unit 101, a display 102 that displays information like images, etc., on the screen on the basis of instructions from the main unit 101, a keyboard 103 for entering various information into the computer system, a non-contact integrated circuit (IC) tag 104 that is attached externally to the front of the main unit 101. The main unit 101 is connected with a mouse 105 for indicating a position on the screen of the display 102, a LAN interface (not shown) for connecting to a local area network (LAN) or a wide area network (WAN) (hereinafter “LAN/WAN”) 106, and a modem 108 for connecting to the public network 107 like the Internet. The LAN/WAN 106 connects another computer system 111, a server 112, a printer 113 etc., to the PC 100. The public network 107 connects the server 110 to the main unit 101 via the modem 108.

As shown in FIG. 2, the main unit 101 comprises, a central processing unit (CPU) 121, a random accesses memory (RAM) 122, a read only memory (ROM) 123, a hard disk drive (HDD) 124, a compact disk (CD) ROM drive 125, a floppy disk (FD) drive 126, an input-output (I/O) interface 127, a LAN interface 128, and an IC tag reader/writer 129. The IC tag reader/writer 129 may be replaced by a two-in-one IC tag reader/writer, which is described later.

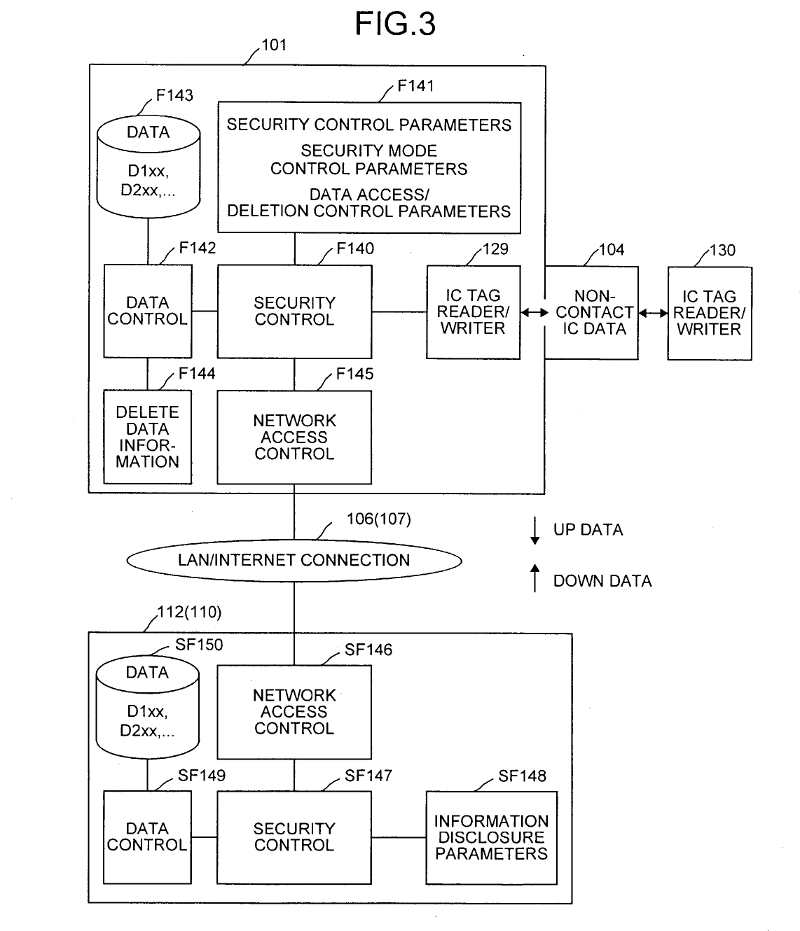

The location-dependent information security management in this computer system works as described below. An IC tag reader/writer (see FIG. 3) 130, which is a transmitter, provided at the entrance of the location where the PC is used writes a code to the IC tag 104 of the main unit of the PC 100. The IC tag reader/writer 129 in the main unit 101 reads the code. In other words, the code of the IC tag reader/writer 130 of the location of the PC 100 is read into the PC 100. The code that is read by the IC tag reader/writer 129 is stored in the RAM 122 via the I/O interface 127. The code is converted to an area code in the CPU 121 and again stored in the RAM 122. The main unit 101 carries out information security control depending on this area code. The information security control functions by setting the security mode or restricting data access or data deletion based on the security mode control parameters or the data access/delete control parameters stored in the hard disk driven by the HDD 124. If the main unit 101 is connected to the LAN/WAN 106 or the public network 107, as shown in FIG. 1 and FIG. 2, the information security control functions by restricting (or allowing access to) information from the server based on the information disclosure parameters inside the server for each area code that is read in the main unit 101.

An information security management device according to the embodiment is explained with reference to the function block diagram shown in FIG. 3. FIG. 3 is obtained by replacing the block diagram in FIG. 2 with the function block diagram of the information security control. The IC tag reader/writer 130 is provided at the entrance of the area. The IC tag reader/writer 130 transmits a code unique to the IC tag reader/writer 130 by write function.

This unique code is written to the IC tag 104 of the main unit 101 of the PC 100 when the PC 100 is brought near the IC tag reader/writer 130 or is carried past the IC tag reader/writer 130.

The IC tag reader/writer 129 reads the unique code written to the IC tag 104. On the basis of the unique code read by the IC tag reader/writer 129, the security mode or the restriction on data access is changed or selection of whether or not to delete data is carried out in the security control block F140. The change of security mode or restriction on data access or selection of whether or not to delete data is carried out based on the parameters in the security control parameter block F141. The change of security mode refers to selection of ID, password or hard disk password. The change of restriction on data access refers to the change in the level of restriction on access of data according to the degree of confidentiality of the data.

As the security control becomes invalid once the unique code of the IC tag reader/writer 130 is copied, an encryption key of high confidentiality level may be included in the IC tag reader/writer 130 and a de-encryption key may be provided in the PC 100.

It is not possible to determine the location where the PC 100 is being used just by reading the unique code by the IC tag reader/writer 129. Therefore an area identification table or an application program may be provided so that verification of de-encryption key may be carried out and area code can be obtained. Alternatively, the unique code of the IC tag reader/writer 130 itself can be made an area identification code, in which case an area identification table or application will not be required.

The data control block 142 controls data control for data file F143 depending on the control information of the security control block F140. If there is an access restriction, the data control block 142 allows only partial access to data, even if correct ID is supplied. Further, the data control block 142 stores the delete data information in the delete data information memory block F144. The delete data information memory block F144 is provided so that the data stored therein remains intact even when delete data is selected and is restored when the PC100 is moved to a location other than the area where the delete data becomes valid.

The network access control block F145 controls access to the networks such as the LAN/WAN 106 and the public network 107 depending on the control information of the security control block F140. The network access control block F145 denies access to the network if, for instance, the ID supplied is incorrect.

The server 112 (or 110) similarly have function blocks. The network access control block SF146 controls access to the LAN/WAN 106 and the public network 107. The security control block SF147 carries out security control based on the security control of the security control block F140 of the main unit 101 of the PC 100. For instance, if there is an access restriction the security control block SF147 allows only partial access based on the parameters of the information disclosure parameter block SF148. The data control block SF149 carries out data control of data file SF150 depending on the control information of the security control block SF147. FIG. 3 presupposes connection of the PC 100 to the LAN/WAN 106 or the public network 107. If the PC 100 is used in isolation, that is, without connecting to the network, there will be no access restriction to the information disclosure parameters for the servers 112 and 110.

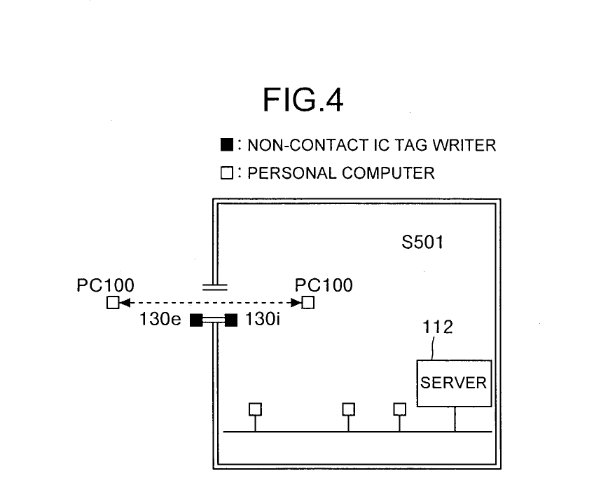

FIG. 4 shows an instance in which the PC 100 is to be used in a room S501 and carried in and out of this room. Ordinarily, while using the PC 100 in the room S501, the user will just need to supply personal identification. However, when carrying the PC 100 out of the room S501, the security control of the PC 100 gets activated by the unique code transmitted by IC tag writers 130i and 130e that are installed near an entrance of the room S501. The security control, for instance, acts by rendering the data in the data file F143 inside the PC 100 as deleted data thereby disallowing access to the data outside the room S501. Conversely, when the PC 100 is carried back into the room S501, the security control that rendered the data as deleted is removed by the unique code transmitted from the IC tag writers 130i and 130e and the user is again allowed an unlimited access just by supplying personal identification. If PC 100 is a personal computer that is brought into the room S501 from another place and is excluded from the LAN connection existing in the room, a security control that renders data from the server 112 as deleted data will come into force. In this manner, when a particular personal computer PC 100 is carried in or out of a particular place several times, security for that area is preserved and re-established by executing the security control on the basis of the unique code history.

The security control is carried out when the PC 100 is boot after it is shifted or it can be carried out periodically when the PC 100 is on.

In this example, the IC tag writer 130i is installed inside and the IC tag writer 130e is installed outside the room S501 and these IC tag writers are means that confirm that the PC 100 has been carried into or out of the room S501 and the direction of the shift. If the IC tag 104 of the PC 100 has the unique codes from both the IC tag writers 130i and 130e, that would indicate that the PC 100 has been carried past the doorway. If the unique code of the tag writer 130i appears first followed by the unique code of the tag writer 130e, it indicates that the PC 100 has been carried out of the room S501. If it is the other way around, that is, the unique code of the tag writer 130e appears first followed by the unique code of the tag writer 130i, it indicates that the PC 100 has been carried into the room S501.

If the IC tag 104 has the unique code of only one of the tag writers 130i and 130e, it indicates that the IC tag 104, and hence the PC 100, belongs to the same location as the IC tag writer. It is effective to have two IC tag writers 130i and 130e, one inside and the other outside the doorway for the type of IC tag 104 on which codes are recorded whenever the IC tag (and hence the PC 100) approaches either of the IC tag writers. However, a second IC tag writer is not required if the IC tag 104 is the type that can judge the direction of shift merely from the code that is recorded when the PC is carried past a single IC tag reader/writer 130. In effect, the IC tag writer transmits a unique code which the IC tag records. Essentially, it should be possible to determine the location of the IC tag, and hence the PC 100 by the unique code from the IC tag writer.

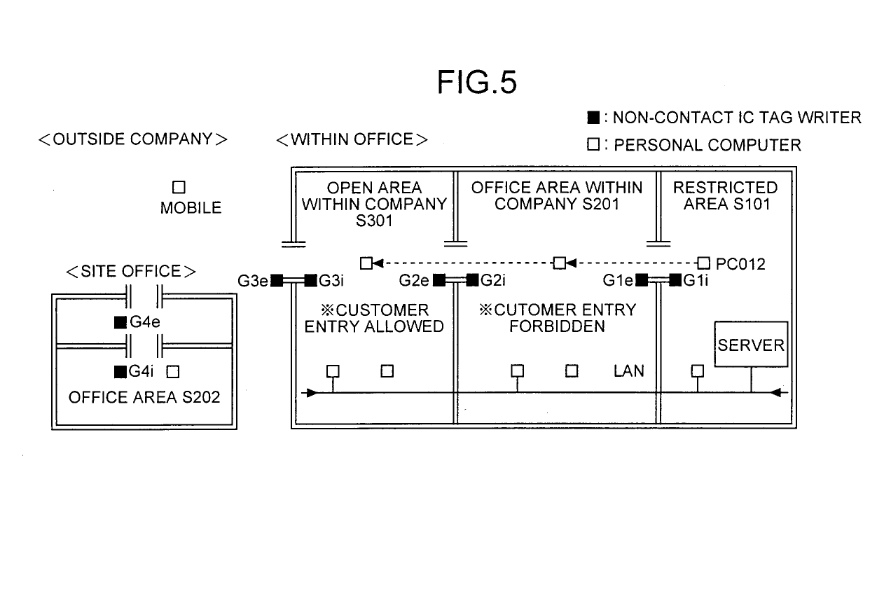

FIG. 5 is an example that has a setup of three rooms S101, S201, and S301 and a site office S202. The room S101 is a restricted area, the room S201 is an office area within a company and an entry of a customer into this room is forbidden, and the room S301 is an open area within the company and a customer may enter this room. In this example, it is assumed that the PC 100 is carried out of the room S101. All the actions described with reference to FIG. 4 are applicable to the example shown in FIG. 5, namely, the PC 100 is both carried out and carried in, the carrying in and carrying out of the PC 100 several times, the security control being executed when the PC is booting or periodically when the PC is on, and the system of IC tag reader/writer 130 and IC tag 104 recording code when they approach each other.

Mainly the security control is explained in detail with reference to FIG. 5. As in FIG. 4, IC tag writers are installed on both sides of the doorway to each of the rooms S101, S201, and S301. Suppose that the PC 100 is carried from the room S101 to the room S301 via the room S201. For the sake of convenience, the PC 100 is indicated by its code PC012, the IC tag 104 is indicated by its code IC123, and the IC tag writers 130i and 130e are indicated by their codes G1i, G1e, G2i, G2e, G3i, G3e, G4i, and G4e.

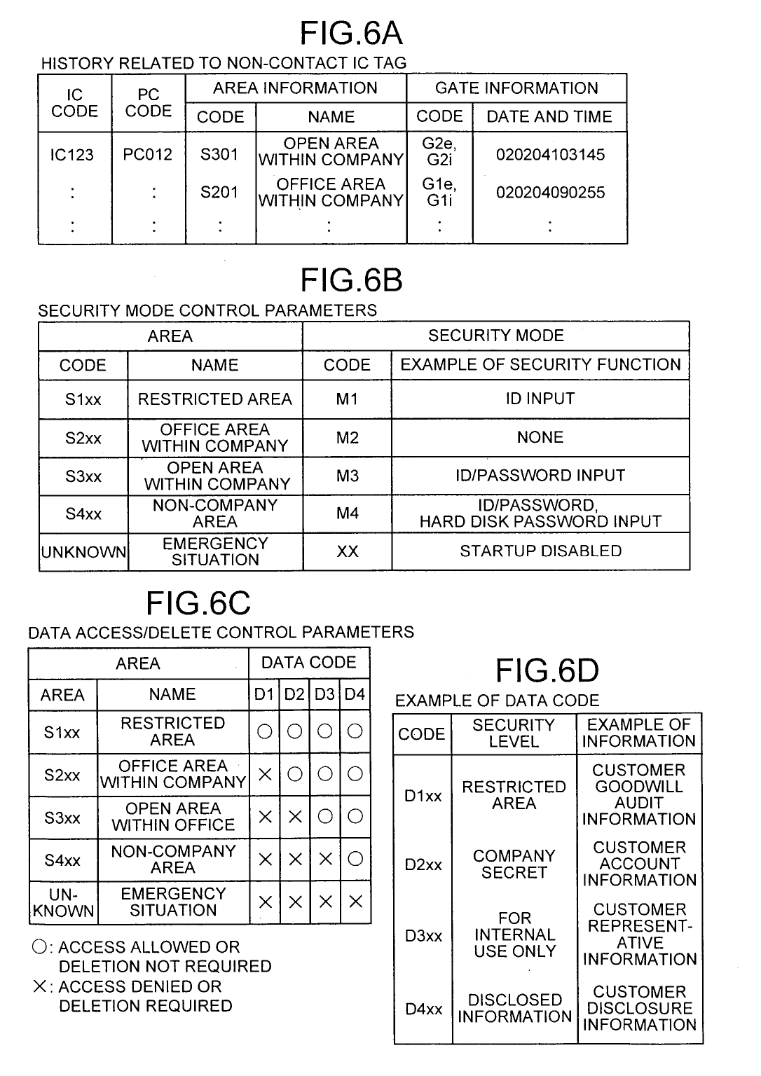

When the PC012 is carried from the room S101 past the doorway, the unique codes G1i and G1e get recorded on the tag IC123. When the PC012 is carried past the next doorway the unique codes G2i and G2e get recorded on the tag IC123. When the PC012 is carried to the room S301, the tag IC123 has the above four codes recorded on it. FIGS. 6A to 6D show the data structure in detail. FIG. 6A shows the history of the IC tag. The fact that the PC012 has been carried from the room S101 to S201 is confirmed by the codes G1i and G1e that are recorded on the tag IC123. Further, the codes G2i and G2e that are recorded on the tag IC123 confirm the fact that the PC012 has been carried from the room S201 to S301. Accordingly, in the security control block F140 of PC012 area codes S201 and S301 are entered (for the sake of convenience the reference numeral of the room itself has been denoted as the area code).

FIG. 6B shows the control parameters for change of security mode when PC012 is shifted as described above. As shown in this figure the area code S101 the security mode is M1, requiring entry of the ‘ID’ of a specific person. For the area code S201 the security mode is M2, which does not require (‘None’) any verification. For the area code S301 the security mode is M3, which requires entry of ‘ID/password’. The figure also shows the change of security mode for the area code S401 and unknown area code. For the area code S401, the security mode is M4, which requires entry of ‘ID/password/hard disk password’. For unknown area code (in the case when the IC tag is not attached), the startup of the computer itself is not allowed.

FIG. 6C shows the data access/delete control parameters. Depending on the area code, data code that can be accessed or not accessed or data code that requires to be deleted or not can be selected. FIG. 6D shows the examples of data codes and their security levels along with an example of each type of data code. The data code D1 refers to restricted information such as customer goodwill audit information. The data code D2 refers to company secrets such as customer account information. The data code D3 refers to information that is for internal use only such as customer representative information. The data code D4 refers to disclosed information such as customer disclosure information. Thus, as shown in FIG. 6C, all data codes D1 through D4 are accessible and not required to be deleted for the area code S101. For the area code S201, access is not allowed or deletion is required for the data code D1 and access is allowed or deletion is not required for the data codes D2 through D4. For the area code S301, access is not allowed or deletion is required for the data codes D1 and D2, and access is allowed or deletion is not required for the data codes D3 and D4. For the area code S401, access is not allowed or deletion is required for the data codes D1 through D3, and access is allowed and deletion is not required for the data code D4. When the area code is unknown, an emergency situation, wherein all the data codes D1 through D4 are made inaccessible and marked for deletion, arises. In this way, the volume of information to which access is denied and which requires to be deleted increases as the PC012 is carried to a location outside the company.

In general, highly confidential information is made difficult to manipulate and is strictly managed. Conversely, information that can be made public is such that it can be easily manipulated and does not require strict management. Security systems in general have so far been working by making it difficult to manipulate highly confidential information any more than is required. On the other hand, even if the information is highly confidential, its security is traded off for easy operability. In the present embodiment, the parameters in FIGS. 6B and 6C are set based on the lay of the rooms shown in FIG. 5. If the risk of information leakage is deemed high, security is given precedence. If the risk of information leakage is deemed low, operability is given precedence.

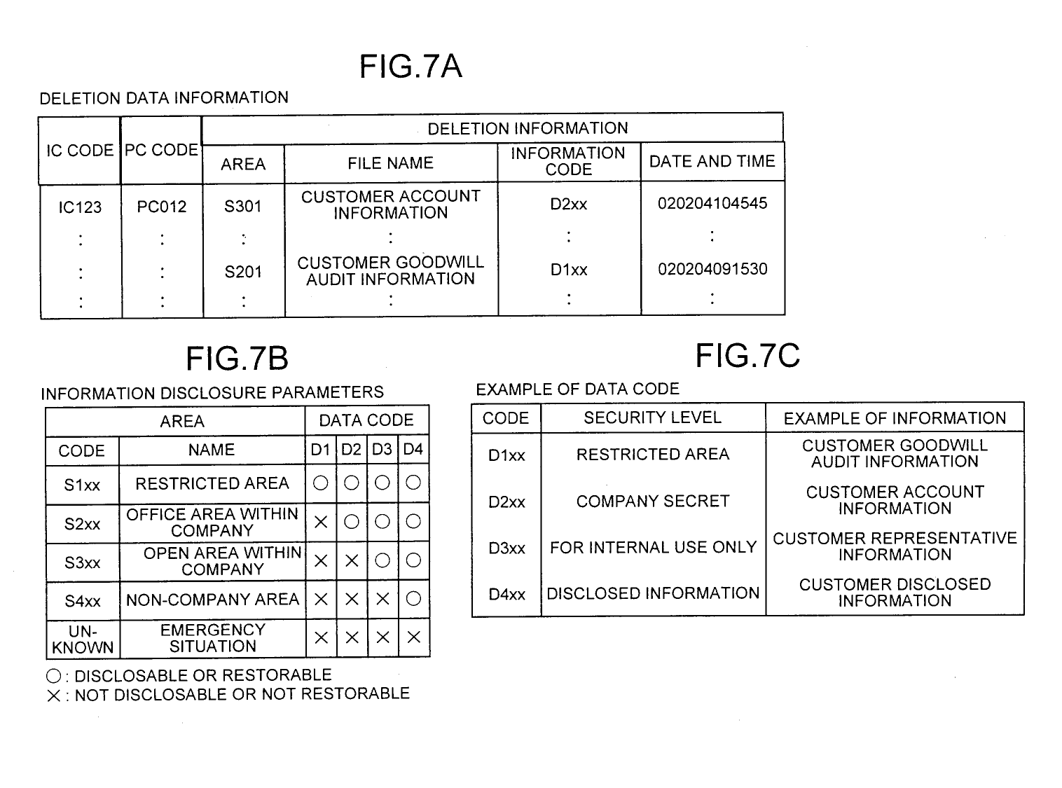

FIG. 7A shows the history of data to be deleted as the place where the PC012 is used is changed. The data code corresponding to the area code is deleted. For instance, when the PC012 is shifted to the room S201, the area code becomes S201, the information represented by the data code D1 is deleted. In the same way, when the PC012 is shifted to the room S301, the area code become S301, the information represented by the data code D2 is deleted. The history of deletion data shown in FIG. 7A is in accordance with the deletion control parameters data structure shown in FIG. 6C.

FIG. 7B shows information disclosure parameters on the side of the server, when the PC012 is connected to the network after being shifted. Data codes shown in FIG. 7C can be selected and set as disclosable or not disclosable or restorable or not restorable. Data deleted by change in the area data is restored and made accessible by sending a restoration request from the PC012. The information disclosure parameters in FIG. 7B and the data codes in FIG. 7C are the same as those in FIG. 6C and FIG. 6D respectively.

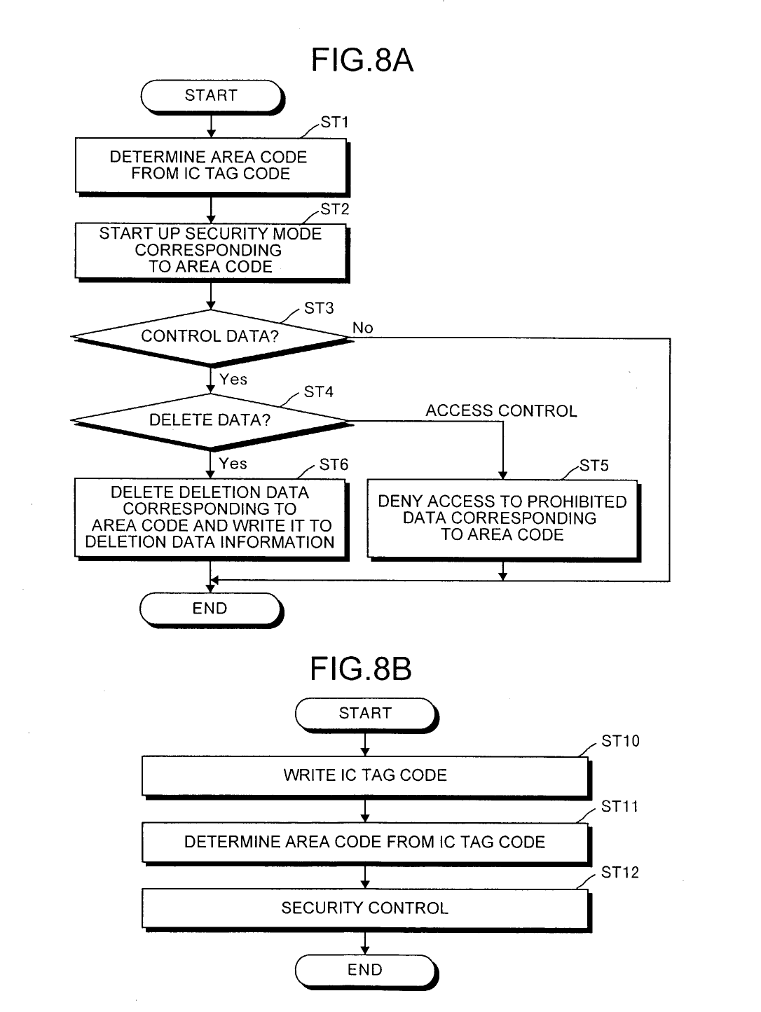

FIG. 8A is a flowchart of the control process of the security control. The area code is first determined from the unique code written to the IC tag 104 (step ST1). The security mode corresponding to the security code is (not consistent with the figure) started up (step ST2) when security control is active during the startup of the PC 100.

It is determined whether data control is required (step ST3). If data control is not required (No at step ST3), the process ends there. However, if data control is required (Yes at step ST3), it is determined whether data deletion is required (step ST4). If data deletion is not required, which means there is access control, (No at step ST4), access to the data corresponding to the area code is denied (step ST5). If data deletion is required (Yes at step ST4), the data corresponding to the area code is written in deletion data information (step ST6). Step ST2 is not required if security control is not required to be done at startup of the PC 100 but is to be carried out periodically when the PC 100 is running.

FIG. 8B is a flow chart that shows writing of a code from the IC tag 104. A unique code that is the gate information is written to the IC tag 104 from the IC tag writer 129 (step ST10). The unique code is converted to a corresponding area code inside the main unit 101 of the PC 100 (step ST11). The security control is launched subsequently (step ST12).

In this embodiment of the present invention, security control is carried out by obtaining a unique code from the IC tag reader/writer 130, the IC tag 104, and the IC tag reader/writer 129. However, security control can be carried out by including a receiver in the PC 100 that receives transmission signals from a global positioning system (GPS) satellite. The GPS works by identifying the location of the PC 100 by obtaining positional information or jointly positional information and time. For the sake of accuracy differential GPS can also be employed.

A computer program that identifies the location of the PC012 and imposes restriction on data manipulation depending on the location where the PC012 is used, can be written. In other words, with the functions in FIG. 3 as a given, a program can be written that makes a computer perform the steps described in FIGS. 8A and 8B based on the parameters given in FIGS. 6A, 6B, 6C, 6D, 7A, 7B, and FIG. 7C.

According to the present embodiment, security control of information can be carried out according to the location where the personal computer is used and the security level by imposing restriction on information manipulation depending on the location where the personal computer is used.

According to the present invention, as a means of security measure, restriction can be imposed on information manipulation of a computer that is portable according to the place where the computer is shifted and used. Thus security measure can be accorded appropriate to the risk involved.

According to the present invention, by having a plurality of locations with a different restriction for each location, it is possible to accord different levels of security measure according to the location.

According to the present invention, restriction is imposed on information that is accessible by a computer that is portable, corresponding to the location where the computer is shifted, the information corresponding to the location being available on a server that is connected to the computer via a network. In this way leakage of information on the network server can be avoided.

According to this invention, by providing a program that identifies the location of a computer and imposes restriction on information manipulation according to the location where the computer is being used, a securing control program can be provided as a computer control program.

According to this invention, by provided a transmitter that outputs area identification signals corresponding to a location where a computer is used, a receiver that receives the area identification signals from the transmitter, and control circuit that carries out imposition of restriction on information manipulation depending on the area identification signals received by the receiver, an effective security measure can be provided against theft or leakage.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information security management method, comprising imposing restriction on manipulation of information by a portable computer based on a location of the portable computer.

2. The information security management method according to claim 1, wherein the location is divided into a plurality of smaller areas, and the method further comprising imposing different restrictions in each of the smaller areas.

3. The information security management method according to claim 1, wherein the imposing restriction involves changing a security mode.

4. The information security management method according to claim 1, wherein the imposing restriction involves changing a right to access data.

5. The information security management method according to claim 1, wherein the imposing restriction involves changing a right to delete data.

6. The information security management method according to claim 5, further comprising allowing recovery of the data deleted based on the location of the portable computer.

7. The information security management method according to claim 1, further comprising identifying the location of the portable computer by the portable computer by receiving a signal from a transmitter installed at each location.

8. The information security management method according to claim 1, further comprising identifying the location of the portable computer by the portable computer by receiving a signal from a global positioning system satellite.

9. The information security management method according to claim 1, further comprising identifying the location of the portable computer each time the portable computer is started up.

10. The information security management method according to claim 1, further comprising identifying the location of the portable computer periodically while the computer is on.

11. An information security management method, comprising imposing restriction on information provided to a portable computer corresponding to a location of the portable computer based on information stored in a server that is connected to the portable computer via a network.

12. The information security management method according to claim 11, wherein the imposing restriction involves changing a security mode.

13. The information security management method according to claim 11, wherein the imposing restriction involves changing a right to access data.

14. The information security management method according to claim 11, wherein the imposing restriction involves changing a right to delete data.

15. The information security management method according to claim 14, further comprising allowing recovery of the data deleted based on the location of the portable computer.

16. The information security management method according to claim 11, further comprising identifying the location of the portable computer by the portable computer by receiving a signal from a transmitter installed at each location.

17. The information security management method according to claim 11, further comprising identifying the location of the portable computer by the portable computer by receiving a signal from a global positioning system.

18. A computer program that realizes on a computer:
detecting a location of the computer; and
imposing restriction on manipulation of information by the computer based on the location of the computer.

19. The computer program according to claim 18, wherein the imposing restriction involves changing a security mode.

20. The computer program according to claim 18, wherein the imposing restriction involves changing a right to access data.

21. The computer program according to claim 18, wherein the imposing restriction involves changing a right to delete data.

22. The computer program according to claim 21, further comprising allowing recovery of the data deleted based on the location of the computer.

23. The computer program according to claim 18, further comprising identifying the location of the computer by the computer by receiving a signal from a transmitter installed at each location.

24. The computer program according to claim 18, further comprising identifying the location of the computer by the computer by receiving a signal from a global positioning system satellite.

25. The computer program according to claim 18, further comprising identifying the location of the computer each time the computer is started up.

26. The computer program according to claim 18, further comprising identifying the location of the computer periodically while the computer is on.

27. An information security management device, comprising:
a transmitter installed in each of a plurality of areas in which a computer may be used and each transmitter outputting a signal that indicates an area in which the transmitter is installed;
a receiver that receives a signal transmitted by the transmitter in the area in which the computer is being used; and
a control unit that imposes restriction on information manipulation by the computer based on the location indicated in the signal received by the receiver.

28. The information security management device according to claim 27, wherein the transmitter is an integrated circuit tag reader writer and the receiver is a non-contact integrated circuit tag.

29. An information security management device, comprising:
a receiver that receives a signal, which indicates a location of the a computer, transmitted by a global positioning system satellite; and
a control unit that imposes restriction on information manipulation by the computer based on the location indicated in the signal received by the receiver.

30. The information security management device according to claim 29, wherein the receiver is fabricated based on differential global positioning system.
